(19) United States
(12) Patent Application Publication
(10) Pub. No.: US 2020/0318771 A1
(43) Pub. Date: Oct. 8, 2020

(54) FLUID APPARATUS AND BUFFER TANK FOR USE THEREIN

(71) Applicant: NITTO KOHKI CO., LTD., Tokyo (JP)

(72) Inventors: Kousei HOUGUCHI, Tokyo (JP); Masahito SHIMADA, Tokyo (JP)

(73) Assignee: NITTO KOHKI CO., LTD., Tokyo (JP)

(21) Appl. No.: 16/904,085

(22) Filed: Jun. 17, 2020

Related U.S. Application Data
(63) Continuation of application No. PCT/JP2018/045243, filed on Dec. 10, 2018.

(30) Foreign Application Priority Data
Dec. 18, 2017 (JP) 2017-241709
Sep. 21, 2018 (JP) 2018-177553

(51) Int. Cl. F16L 55/05; F15B 1/02

(52) U.S. Cl. CPC F16L 55/05; F15B 1/021

(57) ABSTRACT

A fluid apparatus includes an air pump and a buffer tank. The buffer tank has an inlet receiving air delivered from the air pump into a storage space, and an outlet discharging the air from the storage space. The storage space contains a discharge flow passage extending from the outlet toward the inlet in the storage space. The discharge flow passage opens toward the inlet. The discharge flow passage has a tapering flow passage portion with a cross-sectional area gradually decreasing toward the outlet. Compressed air delivered from the inlet into the storage space diffuses in the storage space and is introduced into the discharge flow passage from an introduction opening and delivered from the outlet.

### CROSS-REFERENCE TO RELATED APPLICATIONS

This application is a continuation of International Application No. PCT/JP2018/045243, filed on Dec. 10, 2018, which claims priority to and the benefit of Japanese Patent Application No. 2018177553, filed on Sep. 21, 2018, and Japanese Patent Application No. 2017-241709, filed on Dec. 18, 2017. The disclosures of the above applications are incorporated herein by reference.

### FIELD

The present disclosure relates to a fluid apparatus including a pump and a buffer tank.

### BACKGROUND

A fluid apparatus is configured to periodically suck and compress a fluid through a pump and to deliver the compressed fluid to the outside. Such a fluid apparatus usually includes a buffer tank temporarily storing the fluid delivered from the pump in order to reduce the pulsation of the fluid. The buffer tank is provided with an inlet receiving the fluid delivered from the pump, a storage space for temporarily storing the fluid received through the inlet, and an outlet for delivering the fluid from the storage space to the outside.

The above-described buffer tank of the fluid apparatus is configured to efficiently reduce the pulsation of the fluid, for example, by dividing the interior of the storage space into a plurality of chambers, as disclosed in Patent Literature 1, or by providing a straight pipe extending from the outlet into the storage space, as disclosed in Patent Literature 2, thereby detouring the fluid so that the fluid will not flow directly from the inlet toward the outlet.

### CITATION LIST

### Patent Literature

Patent Literature 1: Japanese Patent Application Publication No. 2010-174798

Patent Literature 2: Japanese Patent Application Publication No. 2013-231379

### SUMMARY

### Technical Problem

The above-described buffer tank suffers, however, from the problem that a relatively large pressure loss occurs in the process of flowing from the inlet to the outlet, causing the fluid delivery efficiency of the fluid apparatus to be degraded to a considerable extent.

Accordingly, an object of the present invention is to provide a buffer tank capable of reducing the pressure loss in comparison to the conventional buffer tank while sufficiently reducing the pulsation of the fluid, and also to provide a fluid apparatus including such a buffer tank.

### Solution to Problem

The present invention provides a buffer tank for use in a fluid apparatus including a pump. The buffer tank includes the following: a storage space configured to temporarily store a fluid delivered from the pump; an inlet opening into the storage space to receive the fluid delivered from the pump into the storage space; an outlet opening to the outside of the buffer tank to discharge the fluid received in the storage space; and a discharge flow passage communicating with the outlet and extending into the storage space to open toward the inlet in the storage space, the discharge flow passage having a tapering flow passage portion with a cross-sectional area gradually decreasing toward the outlet.

In the buffer tank, the discharge flow passage communicating with the outlet opens toward the inlet and has a tapering flow passage portion with a cross-sectional area gradually decreasing toward the outlet. Accordingly, it is possible to reduce the fluid resistance when the fluid delivered from the inlet into the storage space is introduced into the discharge flow passage, and also possible to reduce the fluid resistance when the fluid flows through the discharge flow passage. Consequently, the pressure loss can be reduced in comparison to the above-described conventional buffer tank. Meanwhile, the fluid delivered from the inlet into the storage space also diffuses in the storage space; therefore, the pulsation of the fluid can also be reduced.

Specifically, the arrangement may be as follows. The buffer tank further includes a top wall, a bottom wall, and a side wall which define the storage space. The outlet is formed in the side wall. The buffer tank further includes two intermediate walls extending into the storage space between the top wall and the bottom wall from respective positions of the side wall adjacent to the outlet. The discharge flow passage is defined by the top wall, the bottom wall, and the two intermediate walls.

In this case, the outlet may be configured to touch at least one of the top wall and the bottom wall on the side wall.

With the above-described arrangement, it is possible to reduce the pressure loss when entering the outlet from the discharge flow passage.

Alternatively, the arrangement may be as follows. The buffer tank includes a discharge pipe extending into the storage space, the discharge flow passage being defined by the discharge pipe.

The buffer tank may include a receiving pipe extending into the storage space to receive the fluid delivered from the pump, the receiving pipe defining a receiving flow passage terminating at the inlet.

Further, the inlet may open into the storage space in a direction substantially perpendicular to a longitudinal axis of the discharge flow passage.

With the above-described arrangement, the fluid delivered from the inlet into the storage space is not introduced directly into the discharge flow passage but reaches the discharge flow passage after having diffused to a certain extent in the storage space. Accordingly, the pulsation can be reduced efficiently.

Specifically, the discharge flow passage may be curved at least partially.

In addition, the present invention provides a fluid apparatus including a pump and any of the above-described buffer tanks.

The fluid apparatus may be arranged as follows. The fluid apparatus further includes the following: a cover accommodating the pump and the buffer tank in a state where the pump is placed on the buffer tank, the cover having a delivery port communicated with the outlet of the buffer tank; an elastic support member attached to the cover to support the buffer tank and to suppress propagation of vibration of the buffer tank to the cover; and a pliable tubular connecting member attached between the buffer tank and the cover to provide fluid communication between the outlet of the buffer tank and the delivery port of the cover. The pump is a reciprocating pump in which a pumping action is produced by the reciprocating motion of a reciprocating member. The tubular connecting member has a first attaching portion attached to the buffer tank, a second attaching portion attached to the cover, and an intermediate portion extending between the first attaching portion and the second attaching portion such that at least a part of the intermediate portion extends in a direction substantially perpendicular to the reciprocating direction of the reciprocating member.

With the above-described arrangement, the buffer tank is displaceable relative to the cover within the elastically deformable ranges of the elastic support member and the pliable tubular connecting member. Because the pump is placed thereon, the buffer tank receives the vibration in the reciprocating direction of the reciprocating member from the pump and thus vibrates mainly in the reciprocating direction, together with the pump. The tubular connecting member is not readily deformable in the direction of the longitudinal axis thereof but deformable relatively easily in a direction perpendicular to the longitudinal axis thereof; therefore, the buffer tank is easily deformable relative to the cover, particularly in the direction perpendicular to the longitudinal axis of the tubular connecting member. The direction perpendicular to the longitudinal axis of the tubular connecting member is set to coincide with the reciprocating direction of the reciprocating member of the pump. Therefore, the buffer tank is deformable relative to the cover relatively easily in the reciprocating direction of the reciprocating member. Accordingly, the displacement of the buffer tank in the reciprocating direction of the reciprocating member is not much interfered with by the tubular connecting member, and the vibration of the buffer tank is not much propagated to the cover through the tubular connecting member. Consequently, the vibration is efficiently absorbed by the elastic support member, and it is possible to efficiently reduce the vibration propagated from the pump to the cover through the buffer tank.

Alternatively, the pump and the buffer tank may be formed integrally with each other.

Embodiments of a fluid apparatus according to the present invention will be explained below on the basis of the accompanying drawings.

### DRAWINGS

FIG. 1 is a partially sectioned illustration showing the internal structure of a fluid apparatus according to a first embodiment of the present invention.

FIG. 2 is a perspective view of a buffer tank included in the fluid apparatus shown in FIG. 1.

FIG. 3 is a perspective view of a body part of the buffer tank in FIG. 2, in a state where a lid is detached therefrom.

FIG. 4 is a top view of the body part of the buffer tank shown in FIG. 3.

FIG. 5 is a side sectional view taken along the line A-A in FIG. 4.

FIG. 6 is a side sectional view of a buffer tank in another embodiment.

FIG. 7 is a side sectional view of a fluid apparatus according to a second embodiment of the present invention in a state where a cover is detached therefrom.

FIG. 8 is a perspective view of a fluid apparatus according to a third embodiment of the present invention in a state where an upper cover is detached therefrom.

FIG. 9 is a side sectional view of the fluid apparatus shown in FIG. 8.

FIG. 10 is a sectional view taken along the line B-B in FIG. 9.

### DETAILED DESCRIPTION

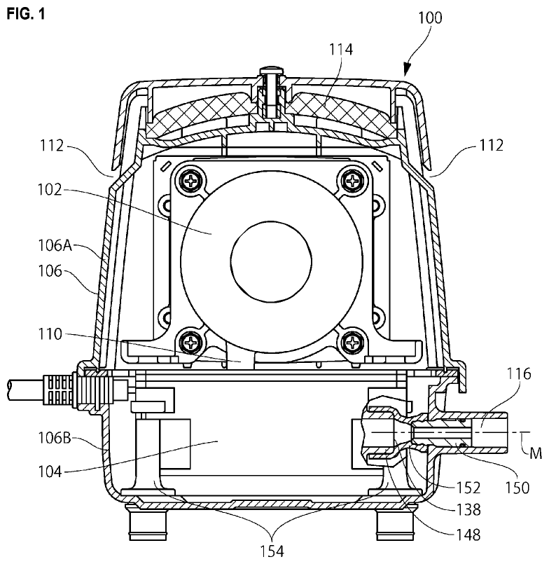

As shown in FIG. 1, a fluid apparatus 100 according to a first embodiment of the present invention includes an air pump 102, a buffer tank 104, and a cover 106 accommodating the air pump 102 and the buffer tank 104. The cover 106 mainly comprises an upper cover 106A and a lower cover 106B. The air pump 102 is a reciprocating pump having a piston (reciprocating member) therein, in which a pumping action is produced by the reciprocating motion of the piston in the depth direction as seen in the figure, thereby sucking and compressing the ambient air and delivering the compressed air from a delivery part 110 of the air pump 102. As the air pump 102 is driven, the ambient air is taken into the interior of the cover 106 from an intake port 112 in the upper cover 106A and sucked into the air pump 102 after passing through a filter 114. The sucked air is delivered from the delivery part 110 of the air pump 102. The delivered compressed air enters the buffer tank 104 as will be described below. After being temporarily stored in the buffer tank 104, the compressed air is delivered to the outside from a delivery port 116 provided in the cover 106.

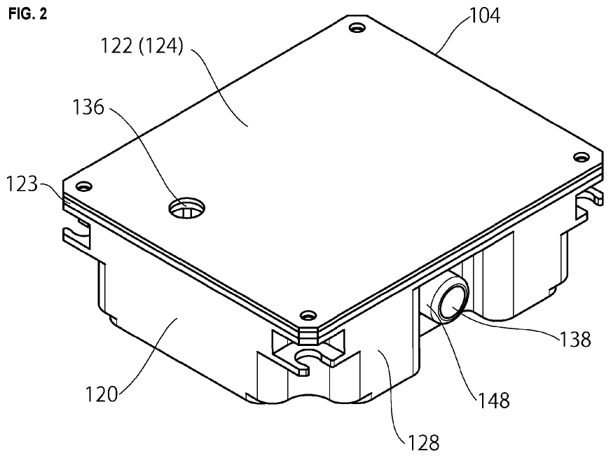

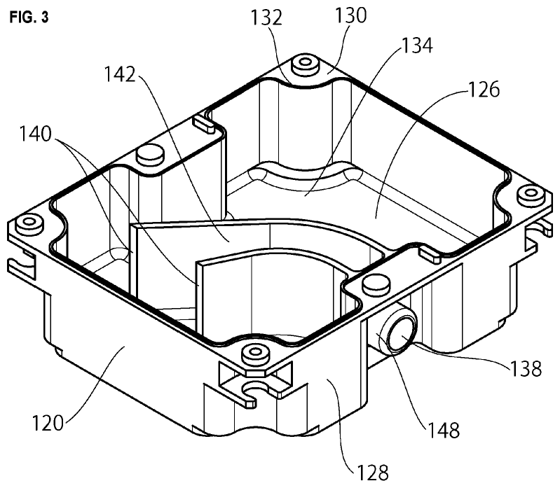

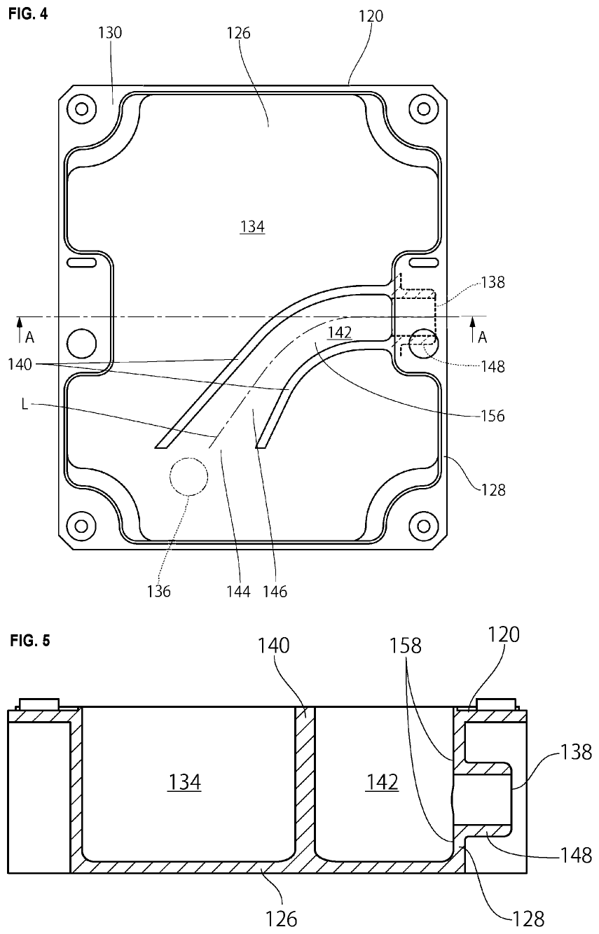

The buffer tank 104 comprises, as shown in FIG. 2, a body part 120, a lid 122, and a rubber seal member 123 sandwiched therebetween to seal the body part 120 and the lid 122 to each other. The lid 122 constitutes a top wall 124 of the buffer tank 104. The body part 120, as shown in FIG. 3, constitutes a bottom wall 126 and a side wall 128. The body part 120 has a flange portion 130 formed with an upwardly projecting annular projection 132 extending in an annular shape along the side wall 128. The annular projection 132 is configured to bite into the seal member 123 sandwiched between the body part 120 and the lid 122, thereby improving the sealing performance, particularly between the body part 120 and the seal member 123. When the lid 122 is attached to the body part 120, a storage space 134 is formed inside the buffer tank 104 by the top wall 124, the bottom wall 126, and the side wall 128. The top wall 124 has an inlet 136 formed therein to open into the storage space 134. The delivery part 110 of the air pump 102 is connected to the inlet 136, so that air delivered from the air pump 102 is received into the storage space 134 from the inlet 136. The side wall 128 has an outlet 138 formed therein to open to the outside of the buffer tank 104, so that the fluid received in the storage space 134 is discharged through the outlet 138. The storage space 134 has, as shown in FIGS. 3 and 4, two intermediate walls 140 formed to extend thereinto from respective positions adjacent to the outlet 138 of the side wall 128 along the bottom wall 126. When the lid 122 is closed, these intermediate walls 140 abut against the top wall 124 and extend between the top wall 124 and the bottom wall 126. The top wall 124, the bottom wall 126 and the two intermediate walls 140 define a discharge flow passage 142 communicating with the outlet 138. The discharge flow passage 142 extends from the outlet 138 while partially curving toward the inlet 136 and terminates at an introduction opening 144 opening toward the inlet 136. The two intermediate walls 140 are formed so that the distance therebetween gradually decreases from the introduction opening 144 toward the outlet 138. Consequently, the discharge flow passage 142 is formed with a tapering flow passage portion 146 having a cross-sectional area gradually decreasing from the introduction opening 144 toward the outlet 138. The inlet 136 formed in the top wall 124 is located outside the discharge flow passage 142 and near the introduction opening 144. The inlet 136 opens into the storage space 134 in a direction perpendicular to the longitudinal axis L of the discharge flow passage 142.

The buffer tank 104 has a tube attaching portion 148 formed on the side wall 128 of the body part 120, and the tube attaching portion 148 projects outward. The outer opening of the tube attaching portion 148 is the outlet 138. As shown in FIG. 1, the delivery port 116 of the cover 106 has a nipple 150 inserted and secured therein, and a pliable rubber tube (tubular connecting member) 152 is attached between the tube attaching portion 148 and the nipple 150. The rubber tube 152 allows connection and fluid communication between the outlet 138 of the buffer tank 104 and the delivery port 116 of the cover 106 through the nipple 150. Further, the buffer tank 104 is supported by four elastic support members 154 attached to the lower cover 106B in such a manner that the buffer tank 104 is floating from the lower cover 106B. The air pump 102 is placed on the buffer tank 104 and accommodated, together with the buffer tank 104, in the cover 106 in no direct contact with the cover 106. Thus, the buffer tank 104 is attached to the cover 106 through the elastic support members 154 and the rubber tube 152. Therefore, the buffer tank 104 is displaceable relative to the cover 106 within the elastically deformable ranges of the elastic support members 154 and the rubber tube 152. Consequently, vibration propagated from the air pump 102 to the buffer tank 104 is absorbed by the elastic support members 154 and suppressed from being propagated to the cover 106. The air pump 102 vibrates particularly greatly in the reciprocating direction of the piston, and hence the buffer tank 104 having the air pump 102 placed thereon also vibrates in the same direction. As will be understood from FIG. 1, the outlet 138 of the buffer tank 104 and the delivery port 116 of the cover 106 are located away from each other on an axis M substantially perpendicular to the reciprocating direction (depth direction as seen in the figure) of the piston, and the rubber tube 152 connecting between the outlet 138 and the delivery port 116 is also disposed to extend in the direction of the axis M. The rubber tube 152 is more easily deformable in a direction perpendicular to the axis direction thereof than in the axis direction. Therefore, it is possible to reduce the vibration propagated to the cover 106 through the rubber tube 152 by disposing the rubber tube 152 so as to extend in the direction of the axis M, which is substantially perpendicular to the reciprocating direction of the piston, which is the vibration direction of the air pump 102. Accordingly, the vibration of the buffer tank 104 is efficiently absorbed by the elastic support members 154, and it is possible to efficiently reduce the vibration propagated from the air pump 102 to the cover 106 through the buffer tank 104. It should be noted that the rubber tube 152 may be a tubular member formed of other pliable material, e.g. a resin.

As the air pump 102 is driven, compressed air is delivered into the buffer tank 104 from the inlet 136 of the buffer tank 104 and blown against the bottom wall 126 to diffuse into the storage space 134, the compressed air being temporarily stored in the storage space 134. Thus, the pulsation of the compressed air is reduced to a considerable extent. The compressed air is also introduced into the discharge flow passage 142 from the introduction opening 144 and flows to the outlet 138 along the discharge flow passage 142. The discharge flow passage 142 has the introduction opening 144 opened wide toward the inlet 136. Therefore, the fluid resistance when the air is introduced into the discharge flow passage 142 decreases. Further, the discharge flow passage 142 gradually decreases in cross-sectional area at the tapering flow passage portion 146, as has been described above, and the discharge flow passage 142 leads to the outlet 138 while smoothly changing the direction at a curved portion 156. Therefore, the fluid resistance when the air flows through the discharge flow passage 142 also decreases. For the reasons described above, the compressed air is smoothly guided from the storage space 134 to the outlet 138, so that it is possible to reduce the pressure loss generated in the buffer tank 104.

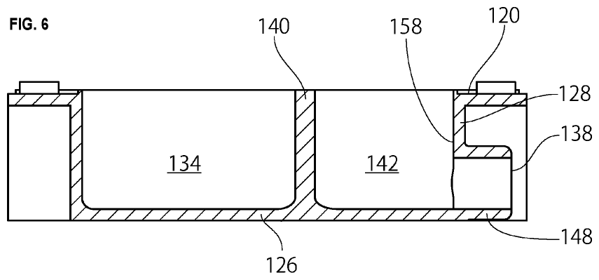

In the buffer tank 104 in this embodiment, as shown in FIG. 5, the outlet 138 is located at an intermediate position in the height direction of the side wall 128. Consequently, steps 158 are formed at the upper and lower sides of the outlet 138 in an area where the discharge flow passage 142 leads to the outlet 138. In an area where the cross-sectional area suddenly changes in this way, the pressure loss is likely to increase. In the buffer tank 104 according to another embodiment shown in FIG. 6, the bottom wall 126 is at the same height as the lowermost portion of the outlet 138, so that the outlet 138 touches the bottom wall 126. Thus, it is possible to reduce the change in the cross-sectional area at the above-described area and to suppress the increase in the pressure loss. It should be noted that, although in the buffer tank 104 shown in FIG. 6, the outlet 138 is configured to touch the bottom wall 126, the outlet 138 may be configured to touch the top wall 124 or to touch both the bottom wall 126 and the top wall 124.

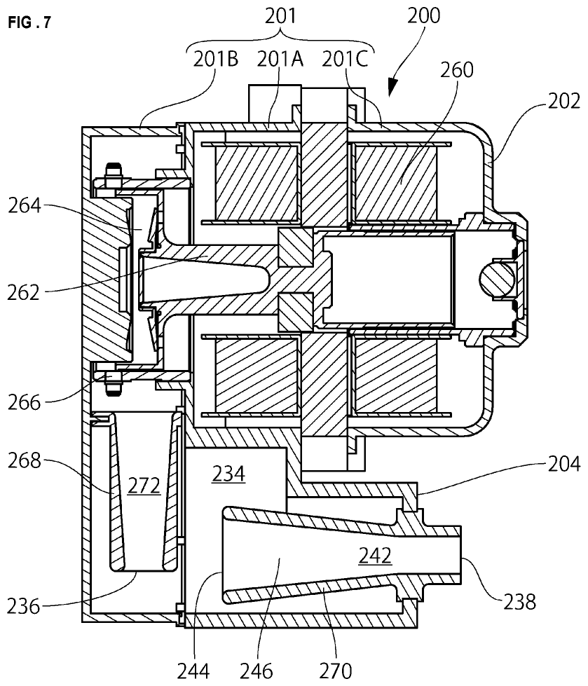

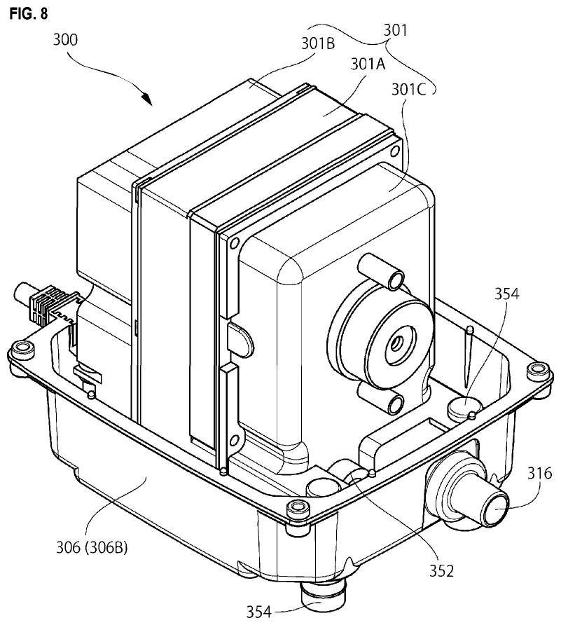

As shown in FIG. 7, a fluid apparatus 200 according to a second embodiment of the present invention has an air pump 202 and a buffer tank 204 which are formed integrally with each other by a casing 201. The air pump 202 is a reciprocating pump similar to the air pump 102 in the above-described first embodiment. A piston (reciprocating member) 262 is linearly reciprocated in the horizontal direction as seen in the figure by the electromagnetic force from an electromagnetic drive part 260, thereby producing a pumping action. Thus, compressed air is delivered through a cylinder opening 266 of a cylinder chamber 264. The casing 201 has a first casing member 201A located in the center, a second casing member 201B extending forward (leftward as seen in the figure), and a third casing member 201C extending rearward (rightward as seen in the figure). The electromagnetic drive part 260 is accommodated between the first casing member 201A and the third casing member 201C. The cylinder chamber 264 is formed between the first casing member 201A and the second casing member 201B. In addition, a storage space 234 of the buffer tank 204 is formed between the first casing member 201A and the second casing member 201B. The buffer tank 204 has a receiving pipe 268 extending into the storage space 234 from the cylinder opening 266 side of the air pump 202 and a discharge pipe 270 extending into the storage space 234 in a direction substantially perpendicular to the receiving pipe 268. The receiving pipe 268 has a receiving flow passage 272 defined therein. The receiving flow passage 272 terminates at an inlet 236 opening into the storage space 234. Accordingly, the compressed air delivered from the air pump 202 is received in the receiving flow passage 272 of the receiving pipe 268 and delivered from the inlet 236 into the storage space 234. The discharge pipe 270 has an introduction opening 244 opening toward the inlet 236 in the storage space 234. The discharge pipe 270 extends straight from the introduction opening 244 to an outlet 238. Further, the discharge pipe 270 has a tapering flow passage portion 246 gradually decreasing in diameter from the introduction opening 244 toward the outlet 238. The compressed air delivered from the inlet 236 into the storage space 234 diffuses in the storage space 234 and is temporarily stored therein, and while doing so, the compressed air is introduced from the introduction opening 244 into a discharge flow passage 242 and delivered to the outside of the fluid apparatus 200 from the outlet 238 through the delivery port of the cover. In the buffer tank 204 of the fluid apparatus 200 also, the discharge flow passage 242 opens toward the inlet 236 and has the tapering flow passage portion 246 with a cross-sectional area gradually decreasing toward the outlet 238, thereby making it possible to reduce the pressure loss generated in the buffer tank 204, in the same way as in the first embodiment.

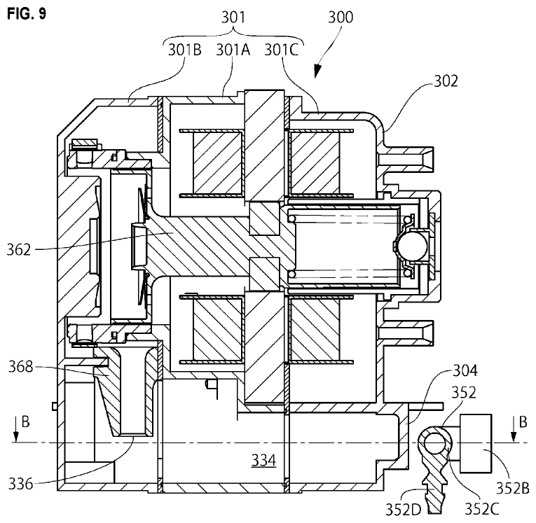

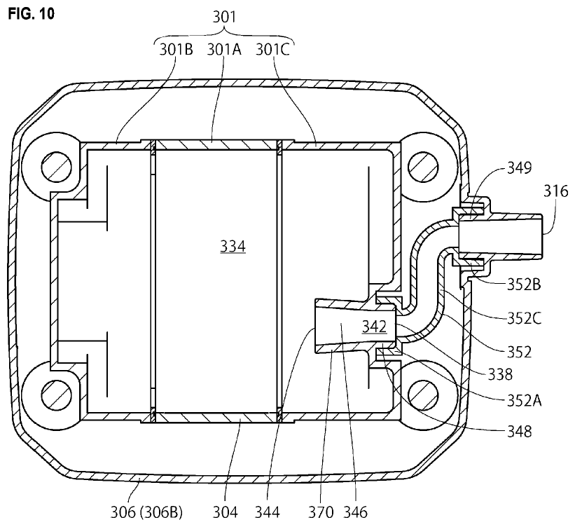

FIGS. 8 to 10 show a fluid apparatus 300 according to a third embodiment of the present invention. The fluid apparatus 300 has an air pump 302 and a buffer tank 304 which are formed integrally with each other by a casing 301, in the same way as the fluid apparatus 200 according to the second embodiment. In the fluid apparatus 300, the buffer tank 304 has a storage space 334 formed by a first casing member 301A, a second casing member 301B, and a third casing member 301C. A discharge pipe 370 is formed integrally with the third casing member 301C. The discharge pipe 370 has an introduction opening 344 opening toward an inlet 336 of a receiving pipe 368. The discharge pipe 370 has a discharge flow passage 342 having a tapering flow passage portion 346 with a cross-sectional area gradually decreasing toward an outlet 338 of the discharge pipe 370. The outlet 338 of the buffer tank 304 and a delivery port 316 of a cover 306 are disposed at respective positions offset from each other in a direction (vertical direction as seen in FIG. 10) substantially perpendicular to the reciprocating direction (horizontal direction as seen in FIG. 10) of a piston 362 of the air pump 302. A pliable rubber tube (tubular connecting member) 352 is attached between the buffer tank 304 and the cover 306. The rubber tube 352 has a first attaching portion 352A attached to a tube attaching portion 348 of the buffer tank 304, a second attaching portion 352B attached to a tube attaching portion 349 of the cover 306, and an intermediate portion 352C extending between the first attaching portion 352A and the second attaching portion 352B in the above-described perpendicular direction. The rubber tube 352 is in a bent shape as shown in the figure and therefore has a high pliability, particularly in the reciprocating direction of the piston 362 of the air pump 302. As the piston 362 of the air pump 302 reciprocates, the casing 301 receives the vibration of the piston 362 and vibrates in the reciprocating direction of the piston 362. In this regard, the vibration is absorbed, particularly by the intermediate portion 352C of the pliable rubber tube 352. Therefore, the vibration of the casing 301 cannot easily be propagated to the cover 306. It should be noted that the casing 301 is attached to a lower cover 306B through elastic support members 354 made of rubber. Accordingly, the vibration of the air pump 302 is also absorbed by the elastic support members 354. In addition, the rubber tube 352 has a securing leg 352D extending downward from the intermediate portion 352C and is secured to the cover 306 by the securing leg 352D. It should be noted that the intermediate portion 352C of the rubber tube 352 need not always have a rectilinear shape as shown in the figure but may have other shape such as a curved shape. Further, the rubber tube 352 may be a tubular member formed of other pliable material such as a resin.

Although some embodiments of the present invention have been described above, the present invention is not limited to the described embodiments. For example, the pump may be other reciprocating pumps, e.g. a diaphragm pump, or may be a pump of other type, e.g. a rotary pump. Further, the targeted fluid is not limited to air. The present invention may also be applicable to a pump configured to deliver other gas or liquid. The configurations of the fluid apparatus according to the first to third embodiments can be applied to each other and freely combined together. For example, the fluid apparatus according to the first embodiment may employ the receiving pipe and the discharge pipe in the fluid apparatus according to the second and third embodiments, and the discharge pipe in the second and third embodiments may be curved. The tapering flow passage portion of the discharge flow passage need not always start from the introduction opening but may be located in an intermediate part of the discharge flow passage. The tapering flow passage portion may extend continuously to the outlet.

### REFERENCE SIGNS LIST

100: fluid apparatus (first embodiment); 102: air pump; 104: buffer tank; 106: cover; 106A: upper cover; 106B: lower cover; 110: delivery part; 112: intake port; 114: filter; 116: delivery port; 120: body part; 122: lid; 123: seal member; 124: top wall; 126: bottom wall; 128: side wall; 130: flange portion; 132: annular projection; 134: storage space; 136: inlet; 138: outlet; 140: intermediate walls; 142: discharge flow passage; 144: introduction opening; 146: tapering flow passage portion; 148: tube attaching portion; 150: nipple; 152: rubber tube (tubular connecting member); 154: elastic support members; 156: curved portion; 158: steps; 200: fluid apparatus (second embodiment); 201: casing; 201A: first casing member; 201B: second casing member; 201C: third casing member; 202: air pump; 204: buffer tank; 234: storage space; 236: inlet; 238: outlet; 242: discharge flow passage; 244: introduction opening; 246: tapering flow passage portion; 260: electromagnetic drive part; 262: piston (reciprocating member); 264: cylinder chamber; 266: cylinder opening; 268: receiving pipe; 270: discharge pipe; 272: receiving flow passage; 300: fluid apparatus (third embodiment); 301: casing; 301A: first casing member; 301B: second casing member; 301C: third casing member; 302: air pump; 304: buffer tank; 306: cover; 306B: lower cover; 316: delivery port; 334: storage space; 336: inlet; 338: outlet; 342: discharge flow passage; 344: introduction opening; 346: tapering flow passage portion; 348: tube attaching portion; 349: tube attaching portion; 352: rubber tube (tubular connecting member); 352A: first attaching portion; 352B: second attaching portion; 352C: intermediate portion; 352D: securing leg 352D; 354: elastic support members; 362: piston; 368: receiving pipe; 370: discharge pipe; L: longitudinal axis; M: perpendicular axis.

What is claimed is:

1. A buffer tank for use in a fluid apparatus including a pump, the buffer tank comprising:
a storage space configured to temporarily store a fluid delivered from the pump;
an inlet opening into the storage space to receive the fluid delivered from the pump into the storage space;
an outlet opening to an outside of the buffer tank to discharge the fluid received in the storage space; and
a discharge flow passage communicating with the outlet and extending into the storage space to open toward the inlet in the storage space, the discharge flow passage having a tapering flow passage portion with a cross-sectional area gradually decreasing toward the outlet.

2. The buffer tank of claim 1, further comprising:
a top wall, a bottom wall, and a side wall which define the storage space, the outlet being formed in the side wall; and
two intermediate walls extending into the storage space between the top wall and the bottom wall from respective positions of the side wall adjacent to the outlet, the discharge flow passage being defined by the top wall, the bottom wall, and the two intermediate walls.

3. The buffer tank of claim 2, wherein the outlet is configured to touch at least one of the top wall and the bottom wall on the side wall.

4. The buffer tank of claim 1, further comprising a discharge pipe extending into the storage space, the discharge flow passage being defined by the discharge pipe.

5. The buffer tank of claim 1, further comprising a receiving pipe extending into the storage space to receive the fluid delivered from the pump, the receiving pipe defining a receiving flow passage terminating at the inlet.

6. The buffer tank of claim 1, wherein the inlet opens into the storage space in a direction substantially perpendicular to a longitudinal axis of the discharge flow passage.

7. The buffer tank of claim 1, wherein the discharge flow passage is curved at least partially.

8. A fluid apparatus comprising:
a pump; and
the buffer tank of claim 1.

9. The fluid apparatus of claim 8, further comprising:
a cover accommodating the pump and the buffer tank in a state where the pump is placed on the buffer tank, the cover having a delivery port communicated with the outlet of the buffer tank;
an elastic support member attached to the cover to support the buffer tank and to suppress propagation of vibration of the buffer tank to the cover; and
a pliable tubular connecting member attached between the buffer tank and the cover to provide fluid communication between the outlet of the buffer tank and the delivery port of the cover;
wherein the pump is a reciprocating pump in which a pumping action is produced by a reciprocating motion of a reciprocating member; and
wherein the tubular connecting member has a first attaching portion attached to the buffer tank, a second attaching portion attached to the cover, and an intermediate portion extending between the first attaching portion and the second attaching portion such that at least a part of the intermediate portion extends in a direction substantially perpendicular to a reciprocating direction of the reciprocating member.

10. The fluid apparatus of claim 8, wherein the pump and the buffer tank are formed integrally with each other.
